(19) United States
(12) Patent Application Publication
(10) Pub. No.: US 2021/0294671 A1
(43) Pub. Date: Sep. 23, 2021

(54) SUBSCRIPTION BASED THIRD PARTY INTEGRATION FRAMEWORK

(71) Applicant: SAP SE, Walldorf (DE)

(72) Inventor: Nils Hirsekorn, Heidelberg (DE)

(21) Appl. No.: 16/825,719

(22) Filed: Mar. 20, 2020

(51) Int. Cl. G06F 9/54

(52) U.S. Cl. CPC G06F 9/541

(57) ABSTRACT

A method and system includes configuring a cloud application to integrate a third party system to the cloud application based on a subscription of the third party system to a first API endpoint of the cloud applciation and using the configured system to redirect requests to the first API endpoint to the subscribed third party system.

### BACKGROUND

For cloud applications, there is typically only one code base for all customers of the cloud application. While this uniformity for all customers might ease and benefit, for example, customer service support for the cloud application, it might also restrict all of the customers to the same application features. In order to fulfill the different needs of customers, cloud applications might be configured to integrate with some third party systems. For example, a customer might want to configure the cloud application to notify a third party system whenever a specific event occurs. Such a configuration may be possible if the desired third party system integration was foreseen or otherwise contemplated by a developer and coded into the cloud application. However, it is nigh impossible for developers to anticipate all of the different types of extensions that might be desired by customers now and throughout the life cycle of a cloud application.

Accordingly, there exists a need for a mechanism that provides an integration of a third party system with a cloud application where the cloud application lacks such an integration.

### BRIEF DESCRIPTION OF THE DRAWINGS

Features and benefits of the example embodiments, and the manner in which the same are accomplished, will become more readily apparent with reference to the following detailed description taken in conjunction with the accompanying drawings.

FIG. 1 is an illustrative depiction of some aspects of a cloud application.

FIG. 2 is an illustrative depiction of a subscription based integration framework, in accordance with some embodiments.

FIG. 3 is an illustrative flow diagram of a process to configure some aspects of a subscription based integration framework, according to some embodiments.

FIG. 4 is an illustrative flow diagram of a process to use a subscription based integration framework, according to some embodiments

FIG. 5 is an illustrative API subscription database table, according to some embodiments.

FIG. 6 is an illustrative example of pseudo-code to implement an interceptor of a subscription based integration framework, according to some embodiments.

FIG. 7 is an illustrative example of code to implement a subscription based integration framework into another framework, according to some embodiments.

FIG. 8 is a block diagram of a computing system, according to some embodiments.

### DETAILED DESCRIPTION

The following description is provided to enable any person in the art to make and use the described embodiments and sets forth the best mode contemplated for carrying out some embodiments. Various modifications, however, will be readily-apparent to those in the art.

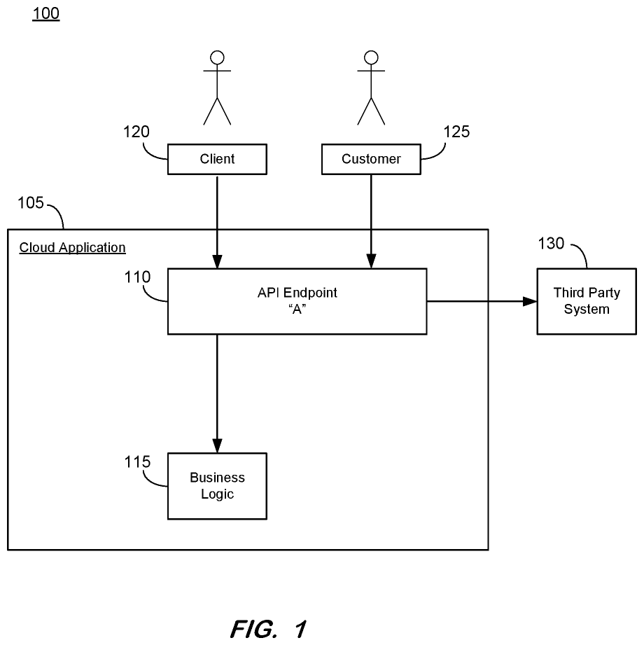

Some embodiments relate to a cloud application and providing additional or enhancing the integration possibilities of the cloud application with a third party system. FIG. 1 is an illustrative overview 100 of certain aspects of a cloud application 105. FIG. 1 includes aspects of a cloud application to the extent relevant to the present disclosure. As such, certain details related to a cloud application that would be understood by one skilled in the art related hereto and/or that are not necessarily required for an understanding of the features disclosed herein might not be explicitly disclosed in FIG. 1 and/or discussed in detail herein.

Cloud application 105 includes an Application Programming Interface (API) that allows communication between the cloud application and client 120, customer 125, and a third party system 130. This API includes endpoints that facilitate communication between specific resources of the cloud application (e.g., business logic 115) and the client, customer, and third party system. The API endpoint “A” is publicly exposed to the client, customer, and third party system as shown in FIG. 1 at 110. The API endpoint to the resource(s) of the cloud application exist but are not explicitly shown in FIG. 1. The possibility of third party system 130 to integrate with cloud application 105 via the API including API endpoint “A” is made feasible by specifying the required configuration of the API during a development (i.e., design time) of the cloud application.

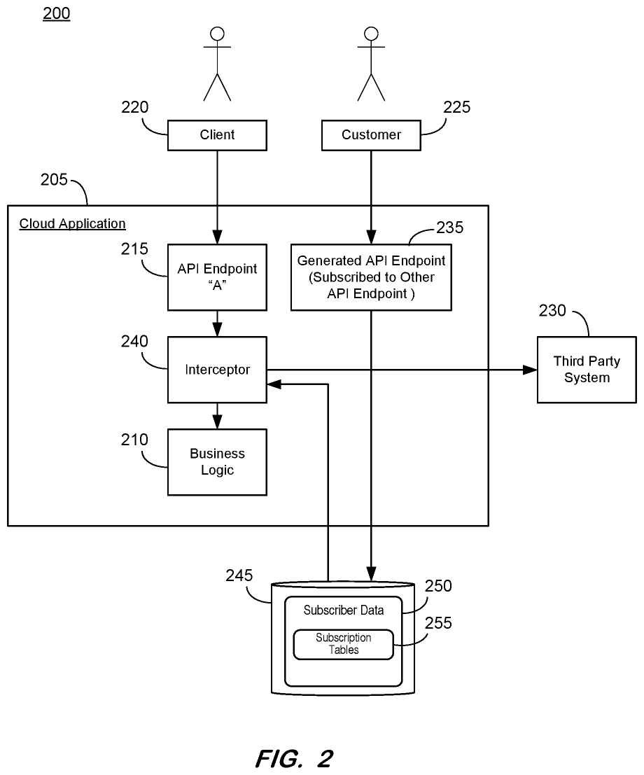

FIG. 2 is an illustrative depiction of a framework 200 that supports a flexible mechanism for extending the integration capabilities of a cloud application beyond the integration(s) configured into the cloud application during a development and design thereof, in accordance with some embodiments herein. Framework 200 includes a cloud application 205 and is designed to have an API configured to facilitate communication between client 220 and business logic 210. The endpoint of the API that supports this communication and is exposed to client 220 is shown as API endpoint “A” at 215.

Framework 200 enables a subscription based third party integration with cloud application 205. For this framework, an API endpoint may be generated for all of the endpoints exposed by cloud application 205 and is referred to herein as a generated API endpoint. Accordingly, framework 200 generates an API endpoint 235 corresponding to exposed API endpoint “A” 215. Generated API endpoint 235 may be used by customers (e.g., customer 225) to subscribe to events and requests (i.e., calls or hits) on API endpoint “A” 215. Generated API endpoint 235 can be configured with integration details (e.g., a specification) for third party system 230 to subscribe to events on API endpoint 215. The configuration information related to the configuration of generated API endpoint 235 is stored in a database 245. Database 245 is generated by framework 200. In some embodiments, database 200 includes subscriber data 250 including subscription tables 255 that includes data representing, at least, the entities (e.g., third party system 230) subscribed to exposed API endpoints (e.g., API endpoint “A” 215) of cloud application 205.

Framework 200 further includes an interceptor 240. Interceptor 240 is a part of framework 200. Interceptor 240 operates to detect or otherwise intercept events and requests to API endpoint “A” 215. Upon detection of an event or request on API endpoint 215, the interceptor may reference database 245 to determine whether any entities are subscribed to API endpoint 215. Interceptor 240 may further notify subscribers to endpoint 215 (e.g., third party system 230 is a subscriber as specified in the configuration of generated API endpoint 235). Additionally, business logic 210 of the cloud application is called in reply to the event or request on API endpoint 215. That is, the original request may be processed as usual, notwithstanding the notifying of the subscribers (if any).

In some embodiments, a generated API endpoint is generated for all API exposed by a cloud application. This scheme of generating a second API endpoint for all of the exposed endpoints of a cloud application provides a mechanism to extend the integration possibilities for each and every one of the exposed (i.e., first or original) API endpoints. Moreover, such a scheme may extend the third party integration of the disclosed framework to all of the exposed API without a need for developers to specifically configure expose API to allow participation with or in framework 200.

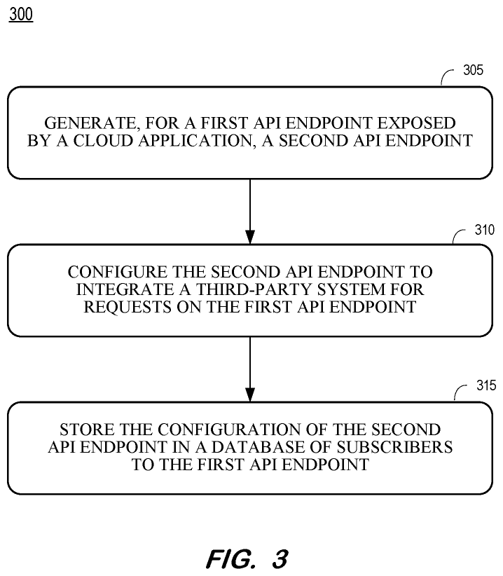

FIG. 3 is an illustrative flow diagram of a process 300 related to a configuration of a framework to facilitate and support a subscription based third party integration, in accordance with some embodiments herein. At operation 305, for each of the API endpoints exposed by a cloud application (i.e., first endpoints), a second API endpoint is generated. This second API endpoint, a generated API endpoint as discussed above, may be used to subscribe to events and/or requests that occur to the corresponding first API endpoint. Whereas the first API might not have been configured to integrate with a particular third party system during a design time, the framework disclosed herein by configuration and use of the second API endpoint, can extend integration of the cloud application to the particular third party.

At operation 310, the second API endpoint is configured to integrate with a desired third party system. Configuration details might include the name and location of the third party system, and other details as required to facilitate the integration of the third party system with the cloud application by an API of the cloud application. In some embodiments, the configuration details and requirements might be dependent on the communication protocol and technologies associated with one or more of the cloud application, the disclosed subscription based third party framework (e.g., FIG. 2, framework 200), and a framework the disclosed subscription based third party framework might interface with.

At operation 315, the configuration of the second (i.e., generated) API endpoint may be stored in a database associated with the disclosed subscription based third party framework. The database may include a data table or other data structure that stores subscribers to the first API endpoint.

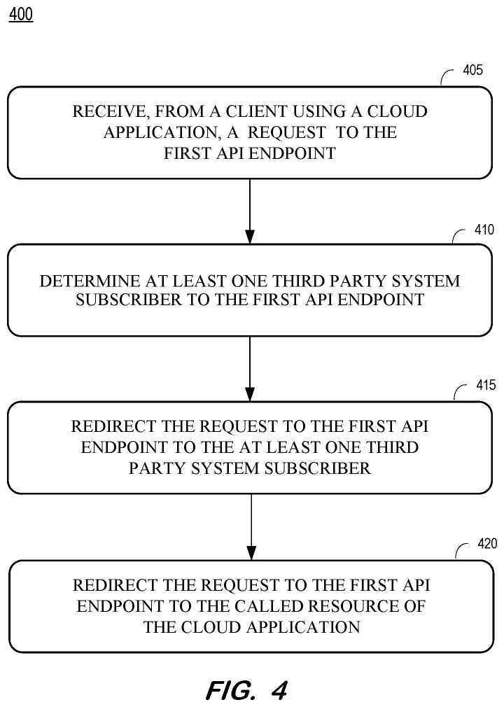

FIG. 4 is an illustrative flow diagram of a process 400 related to a use of a subscription based third party framework disclosed herein, in accordance with some embodiments. At operation 405, a request (e.g., call, hit, or event) to a first API endpoint is received from a client using a cloud application. The use of the cloud application by the client as evidenced by the request on to the first API endpoint may be the type of activity that a customer desires to have trigger an action by a third party system. As such, the customer may have previously subscribed the third party system to events or requests on the first API endpoint via a subscription to a second API endpoint generated by the subscription based third party framework, as disclosed herein. In some embodiments, the request to the first API endpoint may be detected by an interceptor component of the subscription based third party framework.

At operation 410, a determination is made whether there is at least one subscriber to the first API endpoint. The determination may also be performed by the interceptor component or at least invoked thereby. The determination may include the interceptor referencing a data record or other data structure that includes details of the subscribers (if any) to the first API endpoint.

Continuing to operation 415, the request to the first API endpoint may be redirected to the at least one third party system subscribed to the first API endpoint, as determined at operation 410. The redirection may include notifying the third party system of the request to the first API endpoint. In some embodiments, the third party system may initiate a number of actions in response to the notification from the interceptor component herein. One or more, or none, of the actions undertaken by the third party system might involve (or not) further interactions between the third party system and the cloud application.

At operation 420, the request to the first API endpoint is also directed to the resource of the cloud application specified in the request. For example, referring to FIG. 2, the request to the first API endpoint directed to business log 210. In this manner, an interceptor component of a framework herein may operate to redirect the request to the first API endpoint to at least one third party system subscribed to the first API endpoint (if any) and to redirect the request to the first API endpoint to the specified resource of the cloud application (e.g., the specified business logic is called) to process the request as usual.

In some embodiments, a second API endpoint may be generated for every API endpoint exposed by a cloud application. In this scheme or scenario, the generated (i.e., second) API endpoints correspond 1-to-1 with the original, exposed API endpoints and are used by a customer to subscribe to events to the original API endpoints. In a subscriber configuration process related to this scheme, which third party system to notify is specified for each generated API endpoint (i.e., no need to specify the corresponding original API endpoint since each generated API endpoint corresponds to one original, exposed API endpoint). In another configuration scheme or scenario herein, one general API endpoint may be generated that acts as a subscriber entity for all of the API endpoints, no matter how many, that are exposed by a cloud application. In this scheme, the single, general API endpoint corresponds with all of the one or more exposed API endpoints of the cloud application and is used by customers to subscribe to events to the original, exposed API endpoints by specifying, during a configuration process, which third party system to notify and for which particular original API endpoint of the cloud application a given third party system is subscribing to.

As an illustrative example, a client may create a sales order in a cloud application in one scenario. Additionally, a customer may want to be notified when a sales order is created so that a warehouse can be informed to start preparing the sales order. The disclosed subscription based third party framework herein may be leveraged by the customer to subscribe the customer to the API endpoint that handles the creation of sales orders with the configuration details of the warehouse system (i.e., third party system). Having created the subscription as disclosed herein, the warehouse can be notified of the creation of the sales order automatically and immediately in response to its creation. In this manner, this and other use-cases not foreseen or accounted for in the design of the cloud application may be facilitated and supported by the disclosed subscription based third party framework.

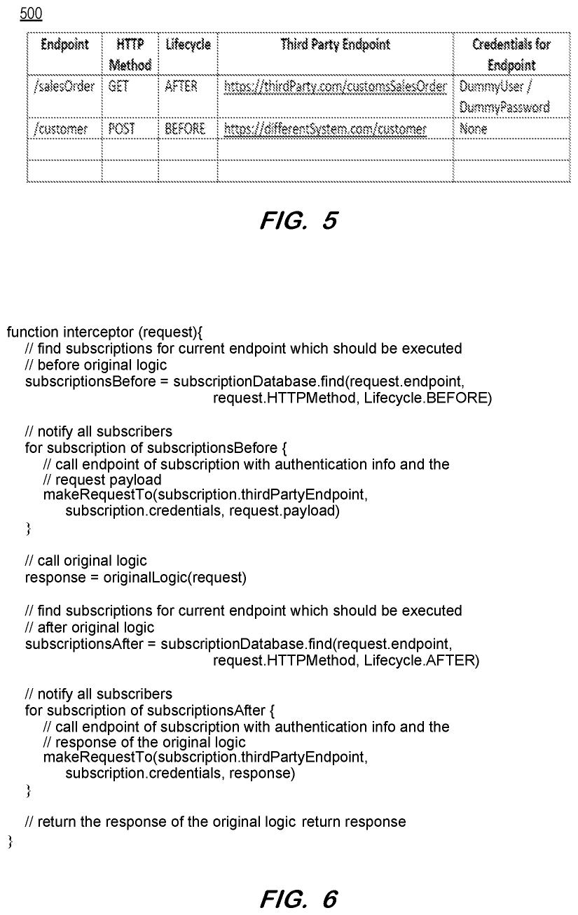

FIG. 5 is an illustrative depiction of a subscription database table 500, in accordance with some embodiments herein. The database table may be used to store subscriber information for subscribers to API endpoints, in conjunction with the configuration and use of a subscription based third party framework disclosed herein. The structure of a subscriber database table herein might vary in some aspects from the example of table 500, however a subscriber database table or other data structure may still include the relevant information.

A sample structure can be found in the following table. Referring to table 500, the first two columns of the table represent the API endpoint for which a subscription is made, including the name of the endpoint at column 505 and the particular method of the API endpoint at 510. In this example, a HTTP endpoint consists of a string of characters and an HTTP Method. For other implementations (e.g., RFC, gRPC, etc.) other, relevant information may be recorded in a subscriber configuration.

Column 315 includes lifecycle information that describe when the third party system should be notified, either before the original logic (e.g., business logic 210 in FIG. 2) is executed or after it has been executed. The sequenced order of the notifications may depend on the preferences of the customer, the third party system, and/or technical constraints of the systems involved. Columns 520 and 525 define the third party system to be notified when the original endpoint is called. Column lists an absolute path to the API endpoint of the third party system including host and credentials at column 525 if the specified API endpoint is secured. In some embodiments, the credentials can be, for example, basic auth. In some embodiment, other authentication mechanisms such as, for example, token based and oAuth may be specified as required depending on implementation details. In some aspects and embodiments, further information may be stored, including for example, the type of authentication mechanism to be used, how it is to be included in a request to the third party system, etc.

FIG. 6 relates to an interceptor component of a subscription based third party integration framework herein (e.g., FIG. 2, 240), according to one embodiment. In particular, FIG. 6 includes a listing of pseudo-code for implementing the interceptor. The listing specifies that if the original API endpoint of the cloud application is called, then an interceptor will be triggered to determine whether there are any subscriptions for this API endpoint and if so, then notify all of the subscribers. The interceptor then also calls the original logic. If the subscriber third party is to get notified after the original logic is executed, the interceptor first executes the original logic code and then notifies the third party system. The pseudo-code listed in FIG. 6 includes annotations regarding the functions specified therein.

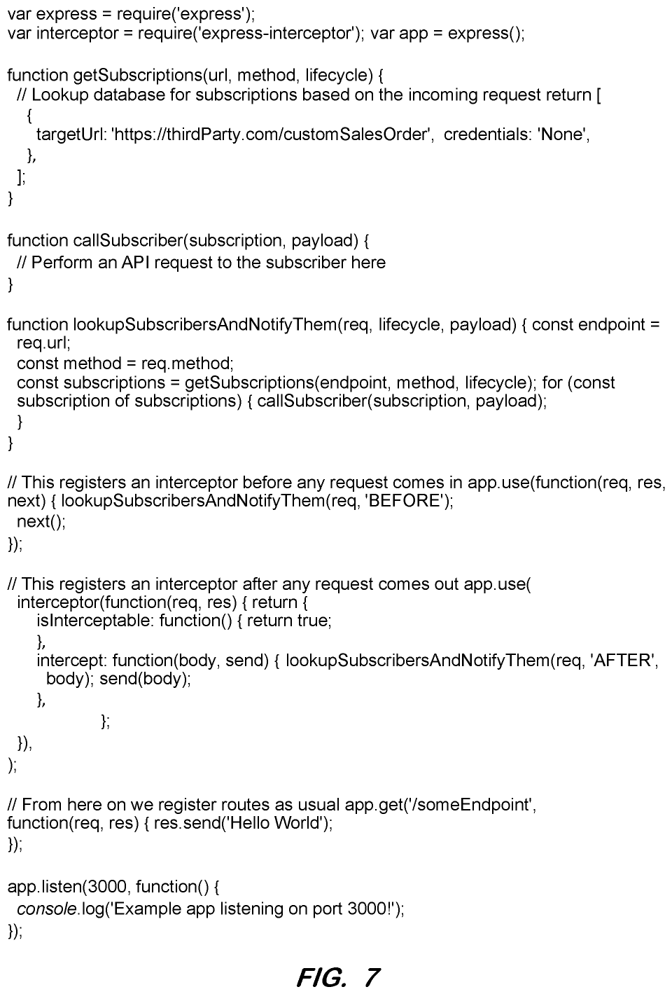

FIG. 7 also relates to an interceptor component of a subscription based third party integration framework herein (e.g., FIG. 2, 240). In particular, FIG. 7 includes a listing of example code for implementing an interceptor that intercepts requests, accesses a database, makes requests to the subscribers, and then calls the original logic. In accordance with some embodiments, all of these functions are technology independent. The pseudo-code listing in FIG. 7 illustratively shows how an interceptor may be integrated in an already existing framework and realized with the node.js framework “express”. The pseudo-code listed in FIG. 6 includes annotations regarding the specified functions therein.

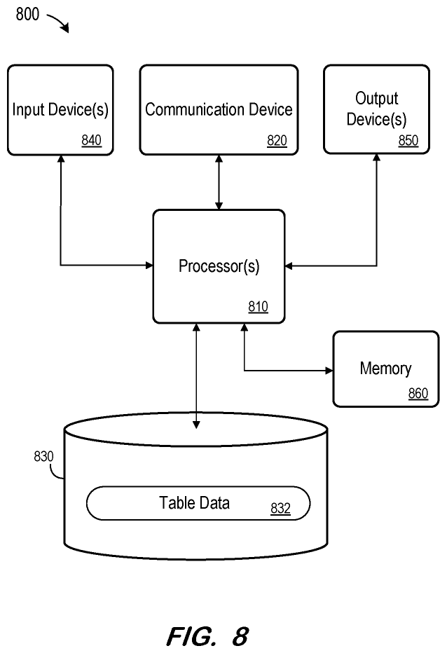

FIG. 8 is a block diagram of server node 800 according to some embodiments. Server node 800 may comprise a general-purpose computing apparatus and may execute program code to perform any of the functions described herein. Server node 800 may comprise an implementation of processes 300 and 400 in some embodiments. Server node 800 may include other unshown elements according to some embodiments.

Server node 800 includes processor(s) 810 operatively coupled to communication device 820, data storage device 830, one or more input devices 840, one or more output devices 850 and memory 860. Communication device 820 may facilitate communication with external devices, such as a client device or a data storage device. Input device(s) 840 may comprise, for example, a keyboard, a keypad, a mouse or other pointing device, a microphone, knob or a switch, an infra-red (IR) port, a docking station, and/or a touch screen. Input device(s) 840 may be used, for example, to enter information into apparatus 800. Output device(s) 850 may comprise, for example, a display (e.g., a display screen) a speaker, and/or a printer.

Data storage device 830 may comprise any appropriate persistent storage device, including combinations of magnetic storage devices (e.g., magnetic tape, hard disk drives and flash memory), optical storage devices, Read Only Memory (ROM) devices, etc., while memory 860 may comprise Random Access Memory (RAM).

Embodiments are not limited to execution of these processes by a single computing device.

Table data 832 may include database data as described above, including subscriber data. Such data may be indexed and/or encoded as described. Data storage device 830 may also store data and other program code for providing additional functionality and/or which are necessary for operation of server 800, such as device drivers, operating system files, etc.

The foregoing diagrams represent logical architectures for describing processes according to some embodiments, and actual implementations may include more or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions. For example, any computing device used in an implementation some embodiments may include a processor to execute program code such that the computing device operates as described herein.

As will be appreciated based on the foregoing specification, the above-described examples of the disclosure may be implemented using computer programming or engineering techniques including computer software, firmware, hardware or any combination or subset thereof Any such resulting program, having computer-readable code, may be embodied or provided within one or more non transitory computer-readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, external drive, semiconductor memory such as read-only memory (ROM), random-access memory (RAM), and/or any other non-transitory transmitting and/or receiving medium such as the Internet, cloud storage, the Internet of Things (IoT), or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor, and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described in connection with specific examples, it should be understood that various changes, substitutions, and alterations apparent to those skilled in the art can be made to the disclosed embodiments without departing from the spirit and scope of the disclosure as set forth in the appended claims.

Embodiments described herein are solely for the purpose of illustration. Those in the art will recognize other embodiments may be practiced with modifications and alterations to that described above.

1. A system comprising:
a memory storing processor-executable program code; and
a processor to execute the processor-executable program code in order to cause the system to:
generate, for a first Application Programming Interface (API) endpoint exposed by a cloud application, a second API endpoint;
configure the second API endpoint to integrate a subscriber system to the cloud application for requests on the first API endpoint; and
store the configuration of the second API endpoint in a database of subscribers to the first API endpoint.

2. A system according to claim 1, the processor to execute the processor-executable program code in order to cause the system to:
receive, from a client using the cloud application, a request to the first API endpoint;
determine at least one subscriber system is subscribed subscriber to the first API endpoint; and
redirect the request to the first API endpoint to the at least one subscribed subscriber system.

3. (canceled)

4. A system according to claim 2, the processor to execute the processor-executable program code in order to cause the system to:
direct the request to the first API endpoint to executable logic of the cloud application to process the request.

5. A system according to claim 4, the processor to execute the processor-executable program code in order to cause the system to:
determine a sequenced order in which to redirect the request to the first API endpoint to the at least one subscribed subscriber system and to direct the request to the first API endpoint to executable logic of the cloud application.

6. A system according to claim 2, wherein the redirecting of the request to the first API endpoint to the at least one subscribed subscriber system comprises notifying the third-party system of the of the request.

7. A system according to claim 1, wherein a second API endpoint is generated for all endpoints exposed by the cloud application.

8. A system according to claim 1, wherein a single instance of the second API endpoint is generated and configured to integrate one or more subscriber systems to the cloud application for requests on all endpoints exposed by the cloud application.

9. A computer-implemented method, the method comprising:
generating, by a processor for a first Application Programming Interface (API) endpoint exposed by a cloud application, a second API endpoint;
configuring, by the processor, the second API endpoint to integrate a subscriber system to the cloud application for requests on the first API endpoint; and
storing the configuration of the second API endpoint in a database of subscribers to the first API endpoint.

10. A method according to claim 9, further comprising:
receiving, from a client using the cloud application, a request to the first API endpoint;
determining at least one subscriber system is subscribed to the first API endpoint; and
redirecting the request to the first API endpoint to the at least one subscribed subscriber system.

11. (canceled)

12. A method according to claim 10, further comprising:
directing the request to the first API endpoint to executable logic of the cloud application to process the request.

13. A method according to claim 12, further comprising:
determining a sequenced order in which to redirect the request to the first API endpoint to the at least one subscribed subscriber system and to direct the request to the first API endpoint to executable logic of the cloud application.

14. A method according to claim 10, wherein the redirecting of the request to the first API endpoint to the at least one subscribed subscriber system comprises notifying the third-party system of the of the request.

15. A method according to claim 9, wherein a second API endpoint is generated for all endpoints exposed by the cloud application.

16. A method according to claim 9, wherein a single instance of the second API endpoint is generated and configured to integrate one or more subscriber systems to the cloud application for requests on all endpoints exposed by the cloud application.

17. A non-transitory, computer readable medium storing instructions, which when executed by at least one processor cause a computer to perform a method comprising:
generating, for a first Application Programming Interface (API) endpoint exposed by a cloud application, a second API endpoint;
configuring the second API endpoint to integrate a subscriber system to the cloud application for requests on the first API endpoint; and
storing the configuration of the second API endpoint in a database of subscribers to the first API endpoint.

18. A medium according to claim 17, storing instructions, which when executed by at least one processor cause a computer to perform a method further comprising:
receiving, from a client using the cloud application, a request to the first API endpoint;
determining at least one subscriber system is subscribed to the first API endpoint; and
redirecting the request to the first API endpoint to the at least one subscribed subscriber system.

19. (canceled)

20. A medium according to claim 18, storing instructions, which when executed by at least one processor cause a computer to perform a method further comprising:
directing the request to the first API endpoint to executable logic of the cloud application to process the request.
